(19) United States
(12) Patent Application Publication
(10) Pub. No.: US 2010/0023201 A1
(43) Pub. Date: Jan. 28, 2010

(54) METHOD AND APPARATUS FOR OBTAINING VEHICLE DATA

(76) Inventors: David Scott Kinney, Everett, WA (US); James L. Millar, Seattle, WA (US); John Bartholomew Maggiore, Seattle, WA (US); Sean Allen Newsum, Bellevue, WA (US); Steven C. Runo, Bellevue, WA (US)

Correspondence Address: DUKE W. YEE, YEE & ASSOCIATES, P.C., P.O. BOX 802333, DALLAS, TX, 75380, US

(21) Appl. No.: 12/179,390

(22) Filed: Jul. 24, 2008

(51) Int. Cl. G06F 7/00

(52) U.S. Cl. 701/33; 701/1; 701/29

(57) ABSTRACT

A computer implemented apparatus, and computer usable program code for automatically obtaining vehicle data. In one advantageous embodiment a computer implemented method monitors a vehicle for events over a wireless interface. In response to receiving an event sent over the wireless interface by the vehicle, a determination is made whether vehicle data is needed for the event based on a policy. A request for the vehicle data is sent over the wireless interface to the vehicle in response to a determination that vehicle data is needed. The vehicle data is stored in response to receiving the vehicle data over the wireless interface from the vehicle. The vehicle data stored after receiving the vehicle data from the vehicle is analyzed to form an analysis. A set of fault conditions may be identified using the analysis.

### BACKGROUND INFORMATION

1. Field

The present disclosure relates generally to an improved data processing system and in particular to a method and apparatus for processing data. Still more particularly, the present disclosure relates to a computer implemented method, apparatus, and computer usable program code for obtaining vehicle data.

2. Background

An aircraft may include one or more computers to perform various functions. These functions include, for example, environmental control systems, aircraft flight control systems, navigation systems, and health monitoring systems. A health monitoring system in an aircraft may be a computer or other device that is connected to other computers and/or sensors in the aircraft. This type of system may collect aircraft data and fault information for use in identifying when repairs or maintenance may be needed.

This type of data may be obtained after an aircraft has landed and/or during flight. Currently, an operator may select data and events that an aircraft health monitoring system may use to generate reports. In response to a particular type of event, the aircraft data processing system may store data or send the data to a ground location.

### SUMMARY

The advantageous embodiments provide a computer implemented apparatus, and computer usable program code for automatically obtaining vehicle data. In one advantageous embodiment, a computer implemented method monitors a vehicle for events over a wireless interface. In response to receiving an event sent over the wireless interface by the vehicle, a determination is made whether vehicle data is needed for the event based on a policy. A request for the vehicle data is sent over the wireless interface to the vehicle in response to a determination that vehicle data is needed. The vehicle data is stored in response to receiving the vehicle data over the wireless interface from the vehicle.

In another advantageous embodiment, a vehicle is monitored for an event. A determination is made as to whether vehicle data is needed for the event based on a policy in response to detecting the event. A request is sent to the vehicle for the vehicle data in response to a determination that the vehicle data is needed.

In yet another advantageous embodiment, an apparatus comprises a policy, a data request process, and a data processing system. The policy identifies a set of conditions of when vehicle data is needed for an event. The data request process is capable of monitoring a vehicle for events over a wireless interface. In response to receiving the event sent over the wireless interface by the vehicle, a determination is made as to whether vehicle data is needed for the event based on the policy. In response to a determination that vehicle data is needed, a request is sent for the vehicle data over the wireless interface to the vehicle. In response to receiving the vehicle data over the wireless interface from the vehicle, the vehicle data is stored. The data request process and the policy are located on the data processing system.

In still yet another advantageous embodiment, a computer program product contains a program code on a computer recordable storage medium. Program code is present for monitoring a vehicle for events over a wireless interface. Program code is also present to receive an event sent over the wireless interface by the vehicle for determining whether vehicle data is needed for the event based on a policy. Program code is present for sending a request for the vehicle data over the wireless interface to the vehicle in response to a determination that vehicle data is needed. Program code is present for storing the vehicle data in response to receiving the vehicle data over the wireless interface from the vehicle.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a pictorial representation of a network of data processing systems in which an advantageous embodiment may be implemented;

FIG. 2 is a diagram of a data processing system in accordance with an advantageous embodiment;

FIG. 3 is a diagram illustrating components used to automatically obtain data from a vehicle in accordance with an advantageous embodiment;

FIG. 4 is a diagram illustrating data flow for requesting vehicle data in accordance with an advantageous embodiment;

FIG. 5 is an illustration of data flow for requesting vehicle data in accordance with an advantageous embodiment;

FIG. 6 is another illustration of data flow for vehicle data in accordance with an advantageous embodiment;

FIG. 7 is a flowchart of a process for obtaining vehicle data in accordance with an advantageous embodiment; and

FIG. 8 is a flowchart of a process for analyzing vehicle data in accordance with an advantageous embodiment.

### DETAILED DESCRIPTION

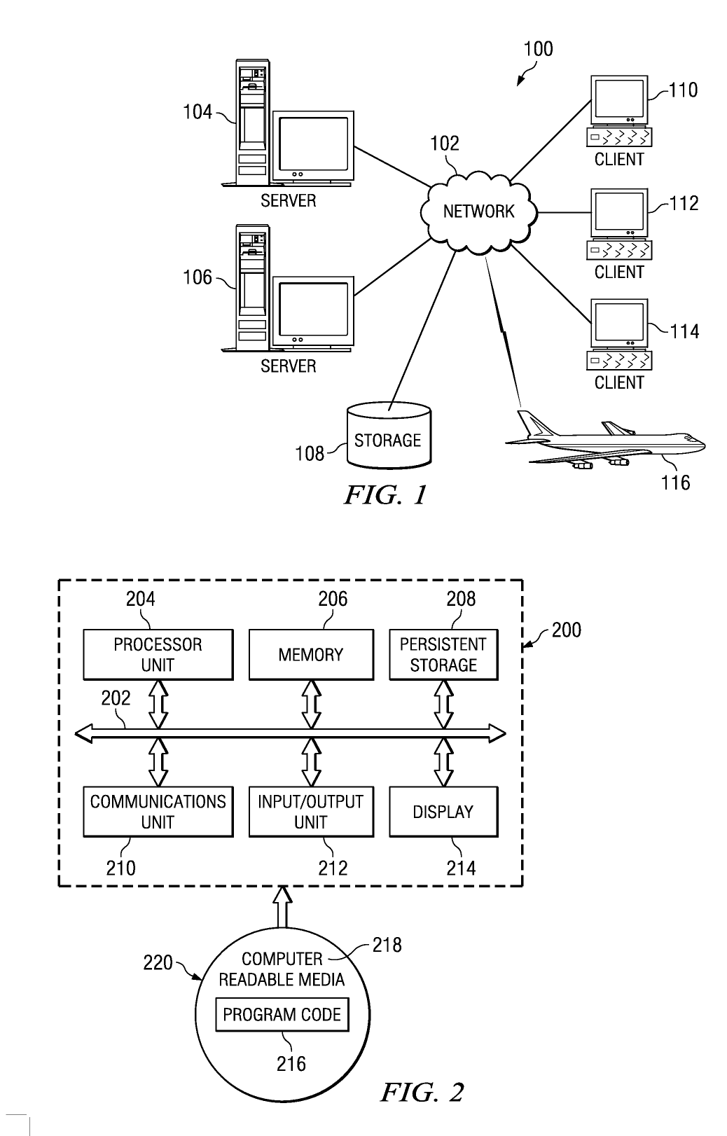

With reference now to the figures and in particular with reference to FIGS. 1-2, exemplary diagrams of data processing environments are provided in which the advantageous embodiments of the present invention may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which the advantageous embodiments of the present invention may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables. In the depicted example, server 104 and server 106 connect to network 102 along with storage unit 108.

In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example.

Aircraft 116 is a client that also may exchange information with clients 110, 112, and 114. Aircraft 116 also may exchange information with servers 104 and 106. Aircraft 116 may exchange data with different computers through a wireless communications link while in flight or any other type of communications link while on the ground. In these examples, server 104, server 106, client 110, client 112, and client 114 may be computers.

Aircraft 116 may generate events and send those events to a computer, such as server 104. Additionally, server 104 may process these events to determine whether additional data is needed. This determination is made using a policy. If additional data is needed from aircraft 116, server 104 may send a request back to aircraft 116 for this additional data. These types of determinations may be made automatically to minimize the possibility that transient data located on aircraft 116 may be lost or no longer exist. In these examples, transient data is data that may be present only temporarily within a data processing system or storage device. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

Turning now to FIG. 2, a diagram of a data processing system is depicted in accordance with an illustrative embodiment. Data processing system 200 is an example of a data processing system that may be used to implement servers and clients, such as server 104 and client 110. Further, data processing system 200 is an example of a data processing system that may be found in aircraft 116 in FIG. 1.

In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. Persistent storage 208 may contain one or more components or devices, such as, for example, a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into a memory, such as memory 206, for execution by processor unit 204. The processes of the different embodiments may be performed by processor unit 204 using computer implemented instructions, which may be located in memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200. The tangible form of computer readable media 218 is also referred to as computer recordable storage media.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The different advantageous embodiments recognize and take into account that although events may be selected for a vehicle to send and/or store vehicle data, this data may be insufficient to perform the desired analysis. Vehicle data is data about the vehicle and/or data gathered by a vehicle. Currently, the data that is downloaded from an aircraft may be a set of predefined reports that are generated automatically in response to an event that is detected by the aircraft data processing system.

The different advantageous embodiments recognize that additional data may be needed to perform additional analysis or to make a recommendation. The different advantageous embodiments recognize that currently, additional data may be identified and/or obtained by an operator or other user requesting the data. These types of requests, however, may not be timely. For example, the different advantageous embodiments recognize that often times, data may be transient. In other words, the data may only last, for example, 10 minutes or a few seconds prior to that data being no longer available.

A turbulence event is a transient condition. Some data, such as flight control surface position, may be captured/saved by the onboard system and stored. However, other data, such as air conditioning pack air in-flow rates surrounding the turbulence event, may be transient and may not be saved. This transient data may be useful for analysis of an air conditioning system anomalous operation during the turbulence event and would otherwise be lost without the different advantageous embodiments.

Examples of transient data include, for example, amount of fuel present at a specific phase of a mission, fuel quantities in individual tanks at different times, engine conditions during startup, engine conditions during shutdown, electrical conditions during start up, electrical conditions during shutdown, engine parameters, and other types of data that may be transient.

As a result, even if the data is analyzed by an operator when the data is received to identify additional data that may be needed, some or all of the additional data may no longer be available after the operator determines that the additional data is needed. Further, even if the additional data were still available, this type of process is time-consuming and expensive.

In recognition and taking into account this problem, the different advantageous embodiments automatically analyze vehicle data from the aircraft data processing system. The different advantageous embodiments monitor the vehicle for events over a wireless interface. This wireless interface may include using a set of communications links. A set as used herein refers to one or more items.

For example, a set of wireless communications links is one or more wireless communications links. In response to receiving an event sent over the wireless interface by the vehicle, a determination may be made as to whether additional vehicle data is needed for the event based on a policy. A policy as used in these examples is a set of rules and/or data that may be used to make determinations as to whether additional data is needed and/or what type of data is needed.

The different advantageous embodiments recognize that relying on an operator to perform an analysis and then determine what additional data may be needed may occur over a period of time during or after which additional data is no longer available or only part of the additional data is available. Further, this type of process may be operator intensive when monitoring an entire fleet of aircraft. As a result, the different advantageous embodiments use a policy to automatically analyze an event to determine whether additional vehicle data and/or what additional vehicle data may be needed. In response to a determination that additional data is needed, the policy may be used to identify that data. A request may then be sent to the vehicle for the additional data.

By using a policy, operator interpretations as to whether data is needed and what data is needed are no longer required. Further, by using a policy, the same type of data may be obtained based on a predetermination of what data may be required for different types of events. In other words, the policy ensures a consistency in the type of additional data that is obtained. When different operators are relied on for identifying the data, different operators may select different types of data for the same events, depending on their interpretations and/or analysis.

In response to a determination that vehicle data is needed, a request is sent for the vehicle data over the wireless interface to the vehicle. In response to receiving the vehicle data over the wireless interface from the vehicle, this vehicle data may be stored. As a result, the loss of transient data may be avoided.

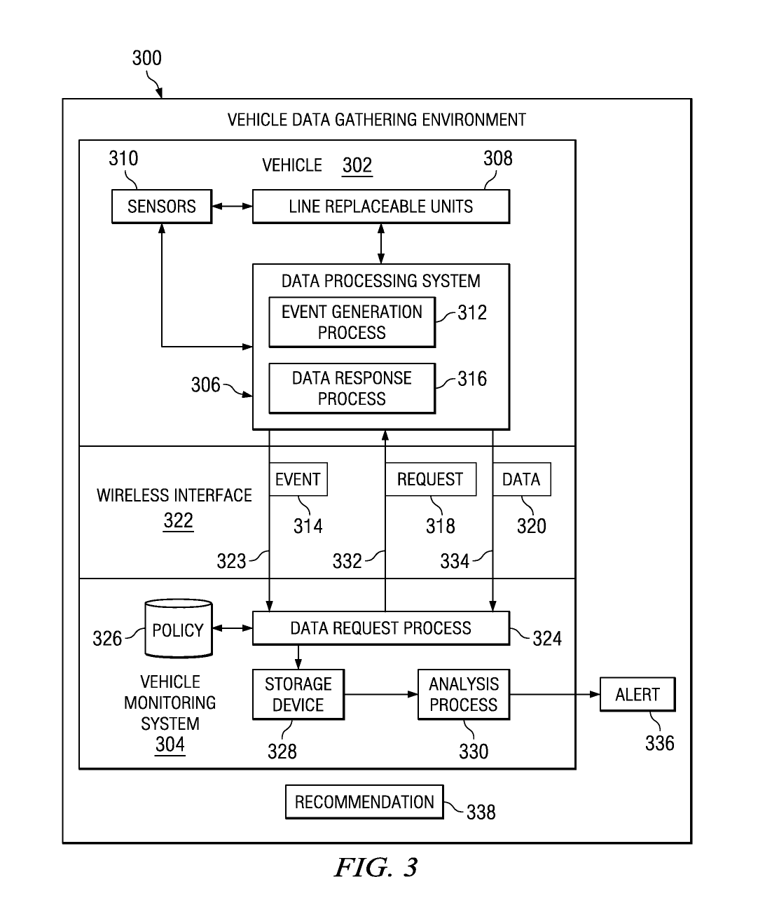

With reference now to FIG. 3, a diagram illustrating components used to automatically obtain data from a vehicle is depicted in accordance with an advantageous embodiment.

In this example, vehicle data gathering environment 300 may include vehicle 302 and vehicle monitoring system 304. Vehicle 302 may be, for example, an aircraft, such as aircraft 116 in FIG. 1. Of course, vehicle 302 may take other forms. For example, vehicle 302 may be, for example, without limitation, a surface ship, a car, a truck, a military ground vehicle, a personnel carrier, a submarine, a spacecraft, or some other vehicle.

Vehicle monitoring system 304 may be a data processing system such as, for example, server 104 in FIG. 1. Vehicle monitoring system 304 may be located at a ground station such as, for example, an airport, a maintenance facility, or some other ground location.

In this example, vehicle 302 includes data processing system 306, line replaceable units 308 and sensors 310. Data processing system 306 may function as a health monitoring system to monitor line replaceable units 308 and other components within vehicle 302. These other components may be monitored using sensors 310. This data may be obtained directly by data processing system 306 from sensors 310 or indirectly through line replaceable units 308. Sensors 310 may include, for example, without limitation, a valve position sensor, a pressure sensor, a temperature sensor, an oxygen pressure sensor, a fuel level sensor, or some other suitable sensor in vehicle 302.

In this example, event generation process 312 executes on data processing system 306. Event generation process 312 may be a process that automatically generates events based on a selection of data and information that is desired for a transmission to vehicle monitoring system 304. In these examples, event generation process 312 may generate events such as event 314. Event 314 may take various forms. For example, event 314 may contain vehicle data or alerts. When vehicle data is included in event 314, this vehicle data may be in raw form or placed into a report.

Data response process 316 also executes on data processing system 306. Data response process 316 may receive requests such as, for example, request 318. In response to receiving request 318, data response process 316 may identify data to be collected and returned as data 320. Data 320 may be vehicle data in these examples. This data may be collected from various components such as, for example, without limitation, sensors 310 and line replaceable units 308.

Data processing system 306 may gather vehicle data in various forms. This vehicle data may include, for example, engine oil quantity, oxygen pressure, tire pressure, hydraulic fluid levels, fuel level, cabin temperature, outside temperature, air pressure, speed, location, and other suitable types of vehicle data.

Data processing system 306 sends event 314 to vehicle monitoring system 304 over wireless interface 322 in these examples. This event may be sent over a communications link such as communications link 323 over wireless interface 322. In these examples, wireless interface 322 is a medium over which communications between vehicle 302 and vehicle monitoring system 304 may be made. This medium is air in these examples. Depending on the type of vehicle, the medium could be a vacuum, or water.

Vehicle monitoring system 304 includes a number of components used to process events such as event 314. In these examples, vehicle monitoring system 304 includes data request process 324, policy 326, storage device 328, and analysis process 330.

Data request process 324 receives event 314 and processes event 314 using policy 326. Data request process 324 stores event 314 in storage device 328 for analysis by analysis process 330. In some advantageous embodiments, data request process 324 may send event 314 directly to analysis process 330.

In these examples, policy 326 is a set of rules and/or data that may be used to identify whether additional data is required to process the event. Further, policy 326 also may be used to identify the type of additional data needed.

Data request process 324 may generate request 318 and send request 318 over communications link 332 across wireless interface 322 to aircraft data processing system 306. Request 318 is processed by data response process 316. Request 318 may be, for example, a request for additional temperature data, register values in a line replaceable unit within line replaceable units 308, or other suitable data. Data response process 316 collects this data using sensors 310 and/or line replaceable units 308. Data 320 is then sent over communications link 334 through wireless interface 322 back to data request process 324.

Also, in these advantageous embodiments, an iterative approach to data analysis may be performed. In other words, based on the data received, additional policies may be triggered to request more data. Several iterations of events, such as data requests, data transmissions, and additional data requests, may allow for enhanced automatic consistent data collection and analysis.

Data 320 may take the form of context sensitive vehicle data in these examples. Context sensitive vehicle data is any vehicle data defined using policy 326 and may be any data relating to an event. As another example, context sensitive vehicle data may be conditions relating to the event. For example, if the original event was a fault, data 320 may be additional data from sensors 310 or a related part of a system in line replaceable unit 308 containing the particular component generating the fault.

In another example, if the event is a particular phase in addition of vehicle 302, the context sensitive vehicle data may be collected based on time. For example, if vehicle 302 is an aircraft in a descent phase, a collection of air pressure data within the aircraft may be gathered every two minutes during the descent phase. In still another example, if the vehicle is in a descent phase, fuel consumption may be collected every five minutes during the descent phase as the context sensitive vehicle data. In these examples, context sensitive vehicle data is data identified using a policy.

Data 320 is received by data request process 324 in these examples and stored in storage device 328. As discussed above, data 320 may trigger additional policies in policy 326 to request additional data allowing for iterative data collection and analysis. Analysis process 330 may obtain data 320 from storage device 328 as well as event 314 and process the data to generate a result.

This result may be, for example, alert 336 and/or recommendation 338. Alert 336 may be generated by analysis process 330. Alert 336 may indicate that an action should be taken. Alert 336 may identify the particular problem or fault of interest. Further, alert 336 may be sent to a maintenance operator and/or vehicle 302. Analysis process 330 also may generate recommendation 338. Recommendation 338 may identify maintenance operations that may be performed with respect to the particular condition.

Analysis process 330 may analyze event 314 and data 320 to determine whether a current condition needs maintenance in when this maintenance may be applied. Analysis process 330 may identify potential conditions that may require maintenance in the future as well as currently occurring conditions. As an example, analysis process 330 may perform trending and/or other statistical analyses.

In this manner, the different advantageous embodiments reduce the amount of time and effort needed to identify conditions that may require maintenance. Further, the different advantageous embodiments provide a capability to obtain data that may be lost using currently employed methods to provide a better analysis. The different advantageous embodiments also provide a capability to automatically identify vehicle data that is needed.

The illustration of vehicle data gathering environment 300 depicts one manner in which advantageous embodiments may be implemented. This illustration is not meant to imply physical or architectural limitations to the manner in which vehicle data gathering environment 300 may be implemented. For example, vehicle monitoring system 304 may be located on another vehicle instead of a ground location. In other advantageous embodiments, vehicle monitoring system 304 may monitor multiple vehicles rather than just vehicle 302. Further, different components may be implemented in code different from the way the functional components have been illustrated. For example, event generation process 312 and data response process 316 may be implemented using a single program rather than two separate components as illustrated in FIG. 3.

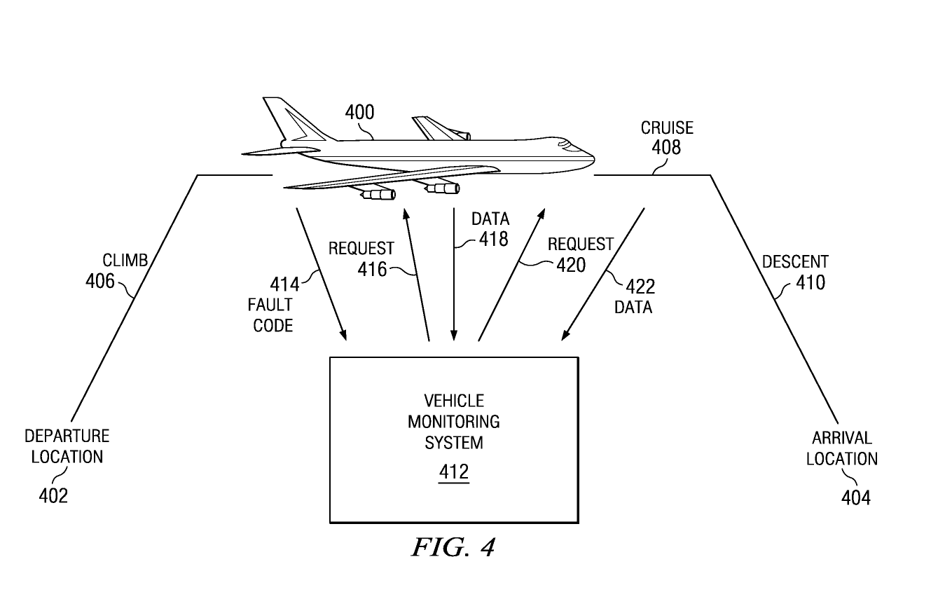

With reference now to FIG. 4, a diagram of data flow for requesting vehicle data is depicted in accordance with an advantageous embodiment. In this example, aircraft 400 has a number of different phases during its mission between departure location 402 and arrival location 404.

These phases include climb 406, cruise 408, and descent 410. Vehicle monitoring system 412 receives an event in the form of fault code 414 from aircraft 400 during cruise phase 408. Vehicle monitoring system 412 is an example of a vehicle monitoring system such as, for example, vehicle monitoring system 304 in FIG. 3.

In response to receiving fault code 414, vehicle monitoring system 412 identifies data that may be required. Request 416 is sent to aircraft 400. In response to receiving request 416, aircraft 400 generates and returns data 418 to vehicle monitoring system 412. Data 418 also may take the form of an event that may require additional data. In this example, data 418 may be processed by vehicle monitoring system 412 to generate request 420 to aircraft 400 to request data 422 to be sent back to vehicle monitoring system 412.

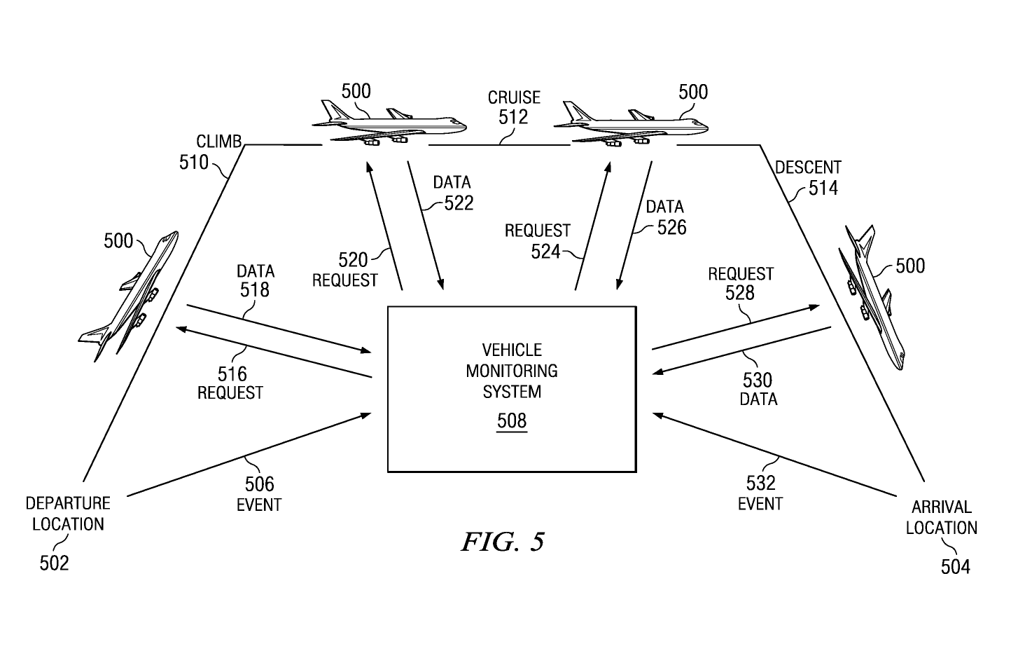

With reference now to FIG. 5, a diagram of data flow for requesting vehicle data is depicted in accordance with an advantageous embodiment.

In this example, aircraft 500 may depart from departure location 502 on a mission to arrival location 504. When aircraft 500 leaves departure location 502, aircraft 500 generates event 506, which is received by vehicle monitoring system 508. Vehicle monitoring system 508 may be implemented using a system such as vehicle monitoring system 304 in FIG. 3. Event 506 may be, for example, a departure location code or merely an indication that aircraft 500 has taken off.

Aircraft 500 may have a number of phases during its mission to arrival location 504. These phases include climb phase 510, cruise phase 512, and descent phase 514. As aircraft 500 travels during its mission, vehicle monitoring system 508 periodically sends requests to aircraft 500 for data in this illustrative example.

For example, vehicle monitoring system 508 sends request 516 after a period of time has passed, while aircraft 500 is in climb phase 510. In response, aircraft 500 returns data 518. After the period of time has passed again, vehicle monitoring system 508 sends request 520 to aircraft 500, while aircraft 500 is in cruise phase 512. In response, aircraft 500 returns data 522. After the period of time has passed again, vehicle monitoring system 508 sends request 524 to aircraft 500 and receives data 526, while aircraft 500 is in cruise phase 512. After the period of time has passed again, vehicle monitoring system 508 sends request 528 to aircraft 500 and receives data 530 while aircraft 500 is in descent phase 514.

This requesting and receiving of data ends when event 532 is received from aircraft 500 upon aircraft 500 landing at arrival location 504. Event 532 may be, for example, an arrival airport code or simply an indication that aircraft 500 has landed.

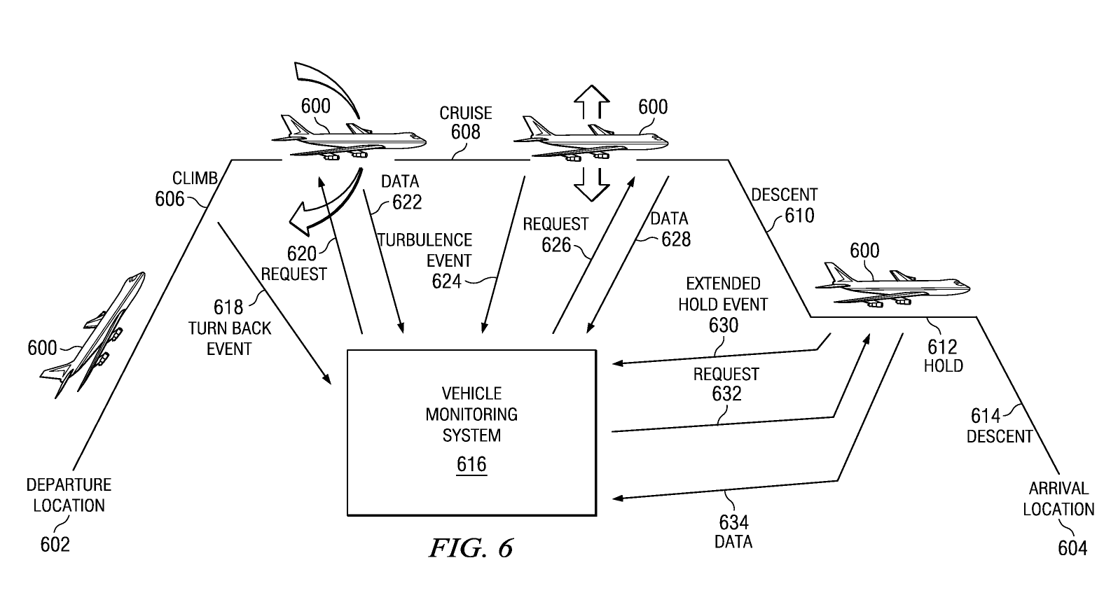

With reference now to FIG. 6, another example of data flow for obtaining vehicle data is depicted in accordance with an advantageous embodiment. In this example, aircraft 600 may depart from departure location 602 on a mission to arrival location 604.

Aircraft 600 may have various phases during its mission. These phases include climb phase 606, cruise phase 608, descent phase 610, hold phase 612, and descent phase 614. During this mission, aircraft 600 may send events and receive requests from vehicle monitoring system 616.

In this example, aircraft 600 sends turn back event 618 to vehicle monitoring system 616. A turn back event occurs when an aircraft makes an unplanned return to a point of origin. A turn back event may occur because of an aircraft problem, weather, or other issue. With turn back event 618, additional information on the health of an aircraft may be used to assess the nature of the problem for resolution upon landing. In response to receiving turn back event 618 during cruise phase 608, vehicle monitoring system 616 sends request 620 to aircraft 600. In response to receiving request 620, aircraft 600 returns data 622.

Later, during the flight in cruise phase 608, aircraft 600 sends turbulence event 624 in this example. Turbulence event 624 indicates that aircraft 600 has encountered severe turbulence. In response to receiving turbulence event 624, vehicle monitoring system 616 sends request 626 to obtain more data relating to the turbulence.

With turbulence event 624, data that may be requested includes, for example, accelerations, air speed changes, or other suitable parameters. This type of information may be used to determine effects on the structure and system components of an aircraft. Further, this information may be used to guide or identify inspections for the aircraft. In response to receiving request 626, aircraft 600 returns data 628 to vehicle monitoring system 616.

During its mission, aircraft 600 may encounter an extended hold phase during hold phase 612. In response to this condition, aircraft 600 may send extended hold event 630 to vehicle monitoring system 616. In response to receiving extended hold event 630, vehicle monitoring system 616 may send request 632 to aircraft 600.

During an extended hold, overall fuel quantity and individual fuel tank quantities are closely monitored to ensure that sufficient fuel quantities are present. Further, this information may be used to manage landings at the intended destination. Further, this information may be used to determine whether to divert the aircraft to another destination. Diversions may occur because of various factors such as, for example, weather or air traffic conditions.

In response to receiving request 632, aircraft 600 sends data 634 back to vehicle monitoring system 616. With this type of information, a number of different types of analyses may be made by vehicle monitoring system 616. For example, when the information includes abrupt air speed changes during turbulence, the analysis may identify a need for airframe and/or engine inspections. The nature and extent of the inspections may be specified in aircraft maintenance documents and may depend on the aircraft configuration as well as the severity of the event.

As another example, a lightning strike may require a system check to ensure that various devices and connections have not been affected. The analysis may identify systems to be tested as well as specific tests. The tests may be identified in the analysis based on the nature and severity of the lightning strike.

In yet another example, the analysis may identify a possibility of effects on the operation and/or functionality of the system or subsystem in response to a loss of another system or subsystem functionality. The analysis may identify tests, inspections, adjustments, or other actions that may be needed to ensure proper subsequent operation or to prevent further fault events. As a specific example, a loss of hydraulic fluid may cause hydraulic pumps and/or tubing to be damaged.

In still another example, the analysis may identify fuel quantity and imbalances. These imbalances may occur with differences in the side-to-side loading of fuel. Further, the analysis also may identify water in the fuel in the information requested. As a result, the analysis may recommend changes in pilot actions during approach or landing. Further, the selection of airports also may change depending on the analysis.

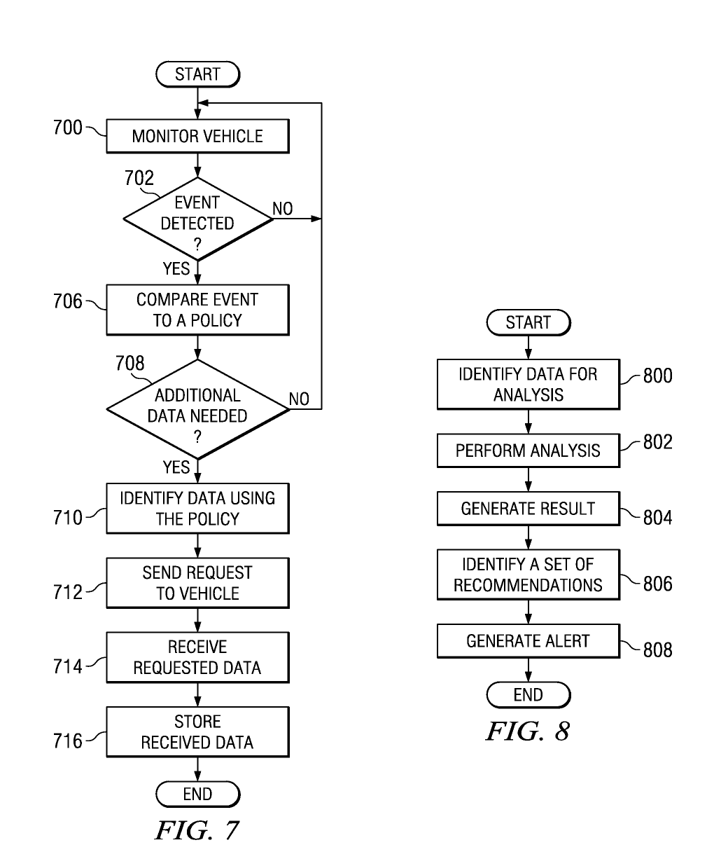

With reference now to FIG. 7, a flowchart of a process for obtaining vehicle data is depicted in accordance with an advantageous embodiment. The process illustrated in FIG. 7 may be implemented in a software component such as, for example, data request process 324 in vehicle monitoring system 304 in FIG. 3.

The process begins by monitoring a vehicle (operation 700). Operation 700 may involve monitoring a wireless interface for transmissions from a vehicle. In other advantageous embodiments, operation 700 may include monitoring a timer set for a vehicle. This timer may be used to generate periodic events to request vehicle data. The process then determines whether an event has been detected (operation 702). This event may be, for example, an event generated by the vehicle and sent to the process. In other advantageous embodiments, the event may be the expiration of the timer.

In response to detecting the event, the event is compared to a policy (operation 706). The policy is used to provide a capability to automatically determine whether additional vehicle data is needed without user intervention. Further, the use of the policy also helps ensure that the requested data is consistent for a particular type of event. As a result, an analysis of similar events from different vehicles may be analyzed with each other or compared to each other. A determination is then made as to whether additional vehicle data is needed (operation 708). This determination may be made using the comparison made to the policy. If additional vehicle data is needed, the vehicle data is identified using the policy (operation 710).

The process then sends a request to the vehicle for data identified using the policy (operation 712). The requested data is then received (operation 714). This received data is stored (operation 716) with the process terminating thereafter.

With reference now to FIG. 8, a flowchart of a process for analyzing vehicle data is depicted in accordance with an advantageous embodiment. The process illustrated in FIG. 8 may be implemented in a component such as, for example, analysis process 330 in vehicle monitoring system 304 in FIG. 3.

The process begins by identifying the vehicle data for analysis (operation 800). In these examples, this data may include a set of events and a set of additional vehicle data that may have been requested. The process then performs an analysis on identified data (operation 802). This analysis may be performed using any currently available analysis process.

Examples of different types of analysis processes may include comparing current engine setting, fuel flow, speed, and altitude data to similar data for idealized flight testing. This comparison may be used to identify changes in aircraft and engine performance. Another example of analysis that may be performed includes comparing tire pressures between different tires on the aircraft. Side-to-side differences between tire pressures may be identified that could induce control problems on landing. Changes in hydraulic fuel levels may be analyzed to identify potential leakage issues.

As another example, change in engine oil may be assessed to identify potential leakage or oil consumption issues. In yet another example, changes in electrical system parameters and trends during auxiliary power unit starting may be used to determine the state of batteries in the aircraft.

The process then generates a result from the analysis (operation 804). The results in operation 804 may be a set of fault conditions. A fault condition is an identification of a fault or potential fault. The fault may be any failure of a component, part, system, subsystem, or other object needed for a vehicle to operate properly and/or as expected.

Thereafter, a set of recommendations are identified (operation 806). These recommendations may include recommendations from maintenance operations, that actions are to be taken, or even that no actions are needed. The process then may generate an alert (operation 808) with the process terminating thereafter. In this example, alert 808 may be an optional step that is implemented depending on the priority of the recommendation. For example, some recommendations may require actions to be taken after the mission for the vehicle has terminated while other recommendations may require immediate actions.

Thus, the different advantageous embodiments provide a computer implemented method, apparatus, and computer usable program code for obtaining and managing vehicle data. The different advantageous embodiments provide a capability to select additional data in addition to predefined data that may be sent by an aircraft during its mission. The identification of the mission data is performed using a policy rather than user input. In this manner, a more consistent type of data may be obtained.

The flowcharts and block diagrams in the different depicted embodiments illustrate the architecture, functionality, and operation of some possible implementations of apparatus, methods and computer program products. In this regard, each block in the flowchart or block diagrams may represent a module, segment, or portion of computer usable or readable program code, which comprises one or more executable instructions for implementing the specified function or functions.

In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The different advantageous embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer usable or computer readable medium providing program code for use by or in connection with a computer or any device or system that executes instructions. For the purposes of this disclosure, a computer usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non limiting examples of a computer readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W) and DVD.

Further, a computer usable or computer readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation to keyboards, touch screen displays, and pointing devices. Different communications adapters may also be coupled to the system to enable the data processing system to become coupled to other data processing systems or remote printers or storage devices through intervening private or public networks. Non-limiting examples are modems and network adapters are just a few of the currently available types of communications adapters.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments.

The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer implemented method for automatically obtaining vehicle data, the computer implemented method comprising:
monitoring a vehicle for events over a wireless interface;
responsive to receiving an event sent over the wireless interface by the vehicle, determining whether vehicle data is needed for the event based on a policy;
responsive to a determination that vehicle data is needed, sending a request for the vehicle data over the wireless interface to the vehicle; and
responsive to receiving the vehicle data over the wireless interface from the vehicle, storing the vehicle data.

2. The computer implemented method of claim 1 further comprising:
analyzing the vehicle data stored after receiving the vehicle data from the vehicle to form an analysis; and
identifying a set of fault conditions using the analysis.

3. The computer implemented method of claim 2 further comprising:
generating a set of recommendations in response to identifying the set of fault conditions.

4. The computer implemented method of claim 2, wherein the analyzing step comprises:
performing a root cause analysis using the vehicle data.

5. The computer implemented method of claim 1, wherein the vehicle is selected from one of an aircraft, a submarine, a surface ship, a car, a truck, a military ground vehicle, a personnel carrier, and a spacecraft.

6. The computer implemented method of claim 2, wherein the set of fault conditions includes an identification of a potential future failure.

7. The computer implemented method of claim 1, wherein the vehicle is an aircraft and wherein the event is received while the aircraft is in flight and further comprising:
analyzing the vehicle data stored after receiving the vehicle data from the aircraft in flight to form an analysis;
identifying as set of fault conditions using the analysis while the aircraft is in flight; and
generating a set of maintenance actions prior to the aircraft completing a mission for the aircraft.

8. The computer implemented method of claim 1 further comprising:
responsive to receiving the vehicle data over the wireless interface from the vehicle, determining if more vehicle data is needed based on the policy; and
responsive to a determination that the vehicle data is needed, sending an additional request for the vehicle data over the wireless interface to the vehicle.

9. A computer implemented method for obtaining vehicle data, the computer implemented method comprising:
monitoring a vehicle for an event;
responsive to detecting the event, determining whether vehicle data is needed for the event based on a policy; and
responsive to a determination that the vehicle data is needed, sending a request to the vehicle for the vehicle data.

10. The computer implemented method of claim 9, wherein the request for the vehicle data is for context sensitive vehicle data associated with the event.

11. The computer implemented method of claim 10 further comprising:
receiving the context sensitive vehicle data from the vehicle; and
analyzing the context sensitive vehicle data to identify a set of fault conditions for the vehicle.

12. The computer implemented method of claim 11, wherein the set of fault conditions comprises a current fault and a potential future fault for the vehicle.

13. The computer implemented method of claim 9, wherein the event is selected from one of a report generated by the vehicle, data generated by the vehicle, a phase of a mission for the vehicle, and a period of time.

14. The computer implemented method of claim 9, wherein the policy comprises a set of criteria indicating when the vehicle data is needed.

15. The computer implemented method of claim 14, wherein the policy further comprises an identification of a type of vehicle data that is needed for the set of criteria.

16. The computer implemented method of claim 15, wherein the type of vehicle data comprises at least one of data relating to a current mission of the vehicle, data relating to an operation environment of the vehicle, and data relating to a line replaceable unit generating the event.

17. An apparatus comprising:
a policy, wherein the policy identifies a set of conditions of when vehicle data is needed for an event;
a data request process, wherein the data request process is capable of monitoring a vehicle for events over a wireless interface; responsive to receiving the event sent over the wireless interface by the vehicle, determining whether vehicle data is needed for the event based on the policy; responsive to a determination that vehicle data is needed, sending a request for the vehicle data over the wireless interface to the vehicle; and responsive to receiving the vehicle data over the wireless interface from the vehicle, storing the vehicle data; and
a data processing system, wherein the data request process and the policy are located on the data processing system.

18. The apparatus of claim 17 further comprising:
an analysis process, wherein the analysis process is capable of identifying a set of fault conditions using the vehicle data stored by the data request process

19. The apparatus of claim 18 further comprising:
a user interface, wherein the user interface is capable of presenting a set of recommendations for the set of faults.

20. The apparatus of claim 19, wherein the vehicle data comprises context sensitive vehicle data for the event.

21. The apparatus of claim 17, wherein the vehicle is selected from one of an aircraft, a submarine, a surface ship, a car, a truck, a military ground vehicle, a personnel carrier, and a spacecraft.

22. A computer program product for automatically obtaining vehicle data, the computer program product comprising:
a computer recordable storage medium;
program code, stored on the computer recordable storage medium, for monitoring a vehicle for events over a wireless interface;
program code, stored on the computer recordable storage medium, responsive to receiving an event sent over the wireless interface by the vehicle, for determining whether vehicle data is needed for the event based on a policy;
program code, stored on the computer recordable storage medium, responsive to a determination that vehicle data is needed, for sending a request for the vehicle data over the wireless interface to the vehicle; and
program code, stored on the computer recordable storage medium, responsive to receiving the vehicle data over the wireless interface from the vehicle, for storing the vehicle data.
